(19) United States
(12) Patent Application Publication
(10) Pub. No.: US 2013/0253963 A1
(43) Pub. Date: Sep. 26, 2013

(54) INTERACTIVE MAPPING SYSTEM AND RELATED METHODS

(71) Applicants: Benjamin C. Harris, Union Town, OH (US); Brian Masuga, Wadsworth, OH (US); Becky Masuga, Wadsworth, OH (US); Mike Howren, Cuyahoga Falls, OH (US); David Komito, Tallmadge, OH (US)

(72) Inventors: Benjamin C. Harris, Union Town, OH (US); Brian Masuga, Wadsworth, OH (US); Becky Masuga, Wadsworth, OH (US); Mike Howren, Cuyahoga Falls, OH (US); David Komito, Tallmadge, OH (US)

(73) Assignee: LUNAR COW DESIGN, Akron, OH (US)

(21) Appl. No.: 13/426,822

(22) Filed: Mar. 22, 2012

(51) Int. Cl. G01C 21/34; G06Q 10/02; G06Q 30/02

(52) U.S. Cl. 705/5; 701/426; 705/14.1

(57) ABSTRACT

Embodiments may relate to an interactive mapping system having a server side content management system (CMS) and at least one database for containing point-of-interest (POI) records. Embodiments may further include a client-side graphical user interface (GUI) enabling users to create itineraries and make purchasing decisions. Embodiments further include means for reporting usage data to a customer, the reports including data provided by users.

### I. BACKGROUND OF THE INVENTION

A. Field of Invention

Embodiments may generally relate to an interactive mapping system and related methods.

B. Description of the Related Art

Interactive mapping systems allow users to generate and/or view maps according to their specific needs or interest in a user-selected geographic area. For instance, systems for determining turn-by-turn directions are known in the art, where a user inputs and starting address and an end address and the system determines a route for the user. Systems are also known for identifying amenities that suit certain user-defined criteria such as hours of operation, location, price, and the like. According to such systems a user may even book an amenity.

One or more embodiments of the invention may provide at least one advantage or innovation over the known art.

### II. SUMMARY OF THE INVENTION

Some embodiments of the present invention relate to an interactive mapping system, comprising: a server-side content management system comprising: at least one database adapted to receive and record customer-provided data records and user input data records, the database containing at least one point-of-interest data record including at least on street address; a means for interfacing with a mapping engine, including transmitting location data to the mapping engine and receiving corresponding geographic coordinates from the mapping engine; a means for transferring customer-provided data from an electronic form to the at least one database; a means for defining at least one point-of-interest including a set of geographic coordinates, and descriptive data including one or more of street address, category, cost of admittance, amenities, and/or rating data, and recording the geographic coordinates and descriptive data in the at least one database; a means for defining at least one point-of-interest area on a first mapping display in data communication with the means for interfacing with the mapping engine including means for selecting predetermined locations on the first mapping display to define vertices of the point-of-interest area, communicating the vertices to the means for interfacing with the mapping engine, receiving geographic coordinates corresponding thereto from the mapping engine, recording the geographic coordinates in the at least one database and displaying indicia representing the vertices on the first mapping display; a means for defining at least one route including a second mapping display in data communication with the means for interfacing with the mapping engine, the second mapping display including a plurality of points-of-interest, the means for defining at least one route further including a means for selecting one or more points-of-interest on the second mapping display, recording the selected points-of-interest as an ordered series of waypoints defining a route, the order of which corresponds to the order in which they were selected and the order in which they are to be visited along the route, and displaying indicia of a the route connecting one waypoint to the next; a client-side user interface in data communication with the server-side content management system, the client-side user interface comprising: a map display area including at least one displayed map, wherein the viewable area of the map is constrained according to predetermined parameters; a user control for displaying one or more predefined points-of-interest on the displayed map; a means for adding one or more of the points-of-interest to an itinerary; a means for a user to share the itinerary with at least one other user; a user control for displaying one or more predefined point-of-interest areas; a user control for displaying one or more predefined point-of-interest routes; and at least one display parameter control selected from one or more of panning, zoom, area selection, satellite view, terrain view, roadmap view, or hybrid view.

According to some embodiments the at least one displayed map in the client side map display area comprises a custom-drawn map of at least one point-of-interest area containing at least one point-of-interest, the custom-drawn map overlaying a map generated by the mapping engine, wherein the custom-drawn map is scaled and aligned to match the scale and alignment of the underlying map.

Some embodiments further comprise a server-side means for defining at least one event taking place at a point-of-interest, the event including a means for purchasing admittance to the event and/or adding the event to an itinerary, wherein one or more events can be displayed in a user interface in the form of a calendar, and wherein the events so displayed are determined to be relevant to the user according to predefined criteria including a user's selections of points-of-interest, routes, and/or itineraries.

Some embodiments further comprise a server-side means for defining questions to be asked of users at predetermined times.

Some embodiments further comprise a GPS feature for providing turn-by-turn directions to or within a point-of-interest from a user's current location, wherein the GPS feature may optionally operate on a custom-drawn map.

Some embodiments further comprise a means for pushing coupons to users based on their proximity to a point-of-interest and their selections of one or more points-of-interest, point-of-interest areas, routes and/or itineraries.

Some embodiments further comprise a booking engine interface providing users with a means for booking items selected from one or more of lodging, automobile rental, event admittance, park admittance, or venue admittance.

Some embodiments further comprise a tool for displaying property amenity data by clicking on a point-of-interest representing the property.

Some embodiments further comprise a flash card containing predefined information relevant to a point-of-interest, wherein the flash card is opened by a click, tap, or touch of visual indicia on an interactive map, and wherein the flash card comprises a popup or callout in proximal to the visual indicia and overlaying a portion of the map.

Some embodiments of the present invention may relate to an interactive mapping system, comprising: a server-side content management system comprising: at least one database containing at least one point-of-interest data record including at least one street address; a means for interfacing with a mapping engine, including transmitting a street address to the mapping engine and receiving corresponding geographic coordinates from the mapping engine; a means for defining at least one point-of-interest including a set of geographic coordinates and recording the geographic coordinates in the at least one database; a means for defining at least one point-of-interest area using at least three geographic coordinates and recording the geographic coordinates in the at least one database; a means for defining at least one route using a plurality of geographic coordinates, configuring the plurality of geographic coordinates as a series of waypoints, and recording the series of waypoints in the at least one database; and a client-side user interface in data communication with the server-side content management system, the client-side user interface comprising: a map display area including at least one displayed map, wherein the viewable area of the map is constrained according to predetermined parameters; a user control for displaying one or more predefined points-of-interest on the displayed map; a means for adding one or more of the points-of-interest to an itinerary; a means for a user to share the itinerary with at least one other user; a user control for displaying one or more predefined point-of-interest areas; and a user control for displaying one or more predefined point-of-interest routes.

According to some embodiments the means for defining at least one point-of-interest area includes a first mapping display in data communication with the means for interfacing with the mapping engine including means for selecting predetermined locations on the first mapping display to define vertices of the point-of-interest area, communicating the vertices to the means for interfacing with the mapping engine, receiving geographic coordinates corresponding thereto from the mapping engine, recording the geographic coordinates in the at least one database and displaying indicia representing the vertices on the first mapping display.

According to some embodiments the means for defining at least one route includes a second mapping display in data communication with the means for interfacing with the mapping engine, the second mapping display including a plurality of points-of-interest, the means for defining at least one route further including a means for selecting one or more points-of-interest on the second mapping display, recording the selected points-of-interest as an ordered series of waypoints defining a route, the order of which corresponds to the order in which they were selected and the order in which they are to be visited along the route, and displaying indicia of a the route connecting one waypoint to the next.

According to some embodiments the at least one displayed map in the client side map display area comprises a custom-drawn map of at least one point-of-interest area containing at least one point-of-interest, the custom-drawn map overlaying a map generated by the mapping engine, wherein the custom-drawn map is scaled and aligned to match the scale and alignment of the underlying map.

Some embodiments further comprise a means for pushing coupons to users based on their proximity to a point-of-interest and their selections of one or more points-of-interest, point-of-interest areas, routes and/or itineraries.

Some embodiments further comprise a flash card displaying data about an item located at a point of interest said information being selected from one or more of educational data, historical data, or purchasing data.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a flow chart showing a process for loading data into an embodiment;

FIG. 2 is a representation of a plurality of example forms for loading data into an embodiment;

FIG. 3. is a schematic diagram showing the flow of information between a database and a mapping engine;

FIG. 4 is a schematic representation of data flow through an embodiment;

FIG. 5 is a schematic representation of an embodiment; and

FIG. 6 is a schematic representation of a client-side architecture of an embodiment.

### IV. DETAILED DESCRIPTION OF THE INVENTION

Some embodiments of the invention may include an interactive mapping system, which can comprise a server side and a client side. The server side may include a means for loading data supplied by a customer and/or user from an electronic form to a server-side database and/or content management system (CMS). Such data may comprise geographic location data including, but not limited to, street address, city, state, and/or zip code data. Embodiments can include a means for interfacing with a mapping engine such as, without limitation, Google Maps®, wherein the server side CMS may relay, for instance, the address of a point-of-interest (POI) to the mapping engine. The mapping engine may then return a set of geographic coordinates to the CMS so that the CMS can locate the POI on a map and mark its location with visual indicia. The coordinates may also be recorded in a database for later recall.

Some embodiments may include means for defining a point-of-interest (POI). Such means can include a database for recording data describing the POI, and can also include means for recording the data in the database. For instance, a means for defining a POI can include an electronic form which can be filled out by, for instance, the owner or manager of a POI and communicated to the provider of an interactive mapping service, i.e. “service provider,” who administers an embodiment. The electronic form can then be read by elements of a content management system (CMS) and recorded in a database for later recall. The means for defining a POI can also include a means for assembling and/or configuring the data elements defining a POI into a convenient data structure. The data defining a POI can include any of a wide variety of suitable data including, without limitation, a name of the POI; street address; geographic coordinates; contact information such as a telephone number, or email address; a website address; lists of amenities; a category indicating the kind of POI, e.g. restaurant, hotel, park, gas station, etc.; photo(s) of a property; custom-drawn map(s) of a property; a written description of the POI, or any combination thereof.

Embodiments, can also include means for defining areas which encompass or contain one or more points-of-interest, i.e. a point-of-interest area. For instance, a point-of-interest area may generally comprise a geographic area such as a park e.g. Grand Canyon National Park, a neighborhood like the French Quarter of New Orleans, or a tourist destination such as Disney World. However, point-of-interest areas can be manually defined to satisfy any convenient boundary conditions. For example, an arbitrary downtown area can be divided into a theater district, a historic district, an east side, a west side, and so on.

Means for defining point-of-interest areas can include a mapping display which displays a map of a general geographic region to be subdivided into areas. The map may be in data communication with a mapping engine, so that clicking a location on the map sends the map location to the mapping engine, which returns a set of corresponding geographic coordinates. The coordinates can then be recorded in a database as a first vertex of a point-of-interest area. This process can be executed at least a total of three times so as to define a minimum of three vertices; however, any number of vertices may be defined so as to adequately define the boundaries of the point-of-interest area. Embodiments may include a means for displaying visual indicia representing the vertices of a point-of-interest area, and may also include boundary lines and/or a colored or shaded area which further indicates the metes and bounds of the point-of-interest area.

A means for defining a point-of-interest area can also include a means for assembling and/or configuring the data elements defining a point-of-interest area into a convenient data structure. The data defining a point-of-interest area can include any of a wide variety of suitable data including, without limitation, a name of the point-of-interest area; a set of vertices defining the point-of-interest area; references to points-of-interest within the point-of-interest area; one or more categories indicating the kind of point-of-interest area; descriptive writings describing the point-of-interest area; or any combination thereof.

Embodiments can include a means for defining one or more routes, trails, or paths, and the like (generically referred to herein as a route), which may include a mapping display in data communication with the means for interfacing with the mapping engine. The mapping display may include a plurality of points-of-interest. In some embodiments a means for defining a route may include a means for selecting one or more of the points-of-interest on the mapping display (e.g. with a mouse click), and recording the selected points-of-interest as an ordered series of waypoints defining a route. For example, the order in which the way points are selected can correspond to the order in which they are to be visited on a route. Furthermore, some embodiments can provide means for displaying indicia of a the route, for instance, by marking POIs with visual indicia and/or connecting one waypoint to the next with lines so as to trace out the route.

Furthermore, a means for defining a route can also include a means for assembling and/or configuring the data elements defining a route into a convenient data structure. The data defining a route can include any of a wide variety of suitable data including, without limitation, a name of the route; a set of waypoints defining the route; references to points-of-interest along the route; one or more categories indicating the kind of route; descriptive writings describing the route; or any combination thereof.

Embodiments can include a client-side graphical user interface (GUI), which may be accessible through the internet. A client-side GUI can include a map display area comprising a tool or control for displaying a map. In some embodiments a map displayed in the map display area may be constrained to a predetermined viewable area so that a user cannot pan beyond certain predefined limits. Furthermore, maps displayed in the map area may be generated by a mapping engine; however, embodiments of the invention include custom-drawn maps which overlay a mapping engine's map. In such embodiments, the custom-drawn map is scaled to match that of the underlying map. Thus, points on the custom-drawn map correspond to equivalent points on the underlying map, which is in data communication with a mapping engine. Therefore, a user is able to view a custom-drawn map while actually interacting with an underlying map.

A GUI may further include a user control for displaying one or more points-of-interest. Furthermore, such a control may include a means for displaying points-of-interest according to their category, a point-of-interest area in which they are encompassed, a route of which they are a waypoint, and/or other grouping parameters as may be advantageous or convenient.

Embodiments may further include an events calendaring system. Some embodiments may include a system that compiles and presents to a user a calendar of events relevant to a POI, POI area, route, and/or itinerary of viewed, accessed, selected or created by the user. For instance, if the user creates an itinerary including a route through the Las Vegas strip which stops at several points of interest, the calendaring system may present a list of available events and activities which are similar or complimentary to the selected points-of-interest. Furthermore, some embodiments may include means for booking an event or activity including making reservations and/or purchasing tickets.

In some embodiments a client-side GUI can include a user control for adding points-of-interest to an itinerary. For example, a user may build an itinerary by selecting one or more points-of-interests, POI areas, and/or routes and using a predetermined control to add the one or more selections to an itinerary. The user may communicate the one or more selections to a subroutine for creating an itinerary, which may include communicating the selections and/or itinerary to a server-side database. In some embodiments, the order in which selections are made can define a default order of items in an itinerary; however, embodiments can also include a means for rearranging items in an itinerary. Embodiments may include a means for assembling and/or configuring a user's selections into a data structure defining an itinerary.

Some embodiments, may provide a means for saving and/or printing an itinerary. For instance, an embodiment may permit a user to save an itinerary to a server-side database after creating an account. Thus, when the user logs back into the account later, he will have access to the saved itinerary. Additionally, some embodiments may provider for a user sharing an itinerary with one or more other individuals. For instance, embodiments may include a means for emailing an itinerary to a user-selected email recipient. In another embodiment, limited access to an itinerary may be granted to communicate the itinerary to a social media account such as a user-selected Facebook® wall, or to a user having certain predetermined credentials.

With further regard to a client-side GUI, one skilled in the art will recognize the advantage of providing users with means for adjusting various viewing parameters such as, without limitation one or more of panning, zoom, area selection, satellite view, terrain view, roadmap view, hybrid view, or any combination thereof.

Some embodiments, such as hand-held mobile app embodiments, may include a custom map showing points of interest within one or more predefined areas and/or point-of-interest areas. Such embodiments may include a GPS feature showing the current location of the hand-held device in the context of the map. Thus, the custom-drawn map can be used in connection with a user's hand-held device to navigate through an area and to find points of interest therein.

Still further, embodiments can include visual indicia representing POIs which are active so that interacting with the indicia causes a flash card to appear. In this context the term flash card includes a set of data which is assembled and presented to a user so to communicate information relevant to the POI. Such information can include educational data, prices, amenities, or any other information that may be of interest to the user. The information may be presented in a form that is quickly and easily understood such as, for instance, a bulleted list of facts on a small popup or callout. In some embodiments a flash card may close and/or disappear after the user ceases interaction or at the direction of the user. For instance, a flash card may open when a POI is clicked, tapped, or touched; and may close when the POI is clicked, tapped, or touched a second time or after a predefined period of time.

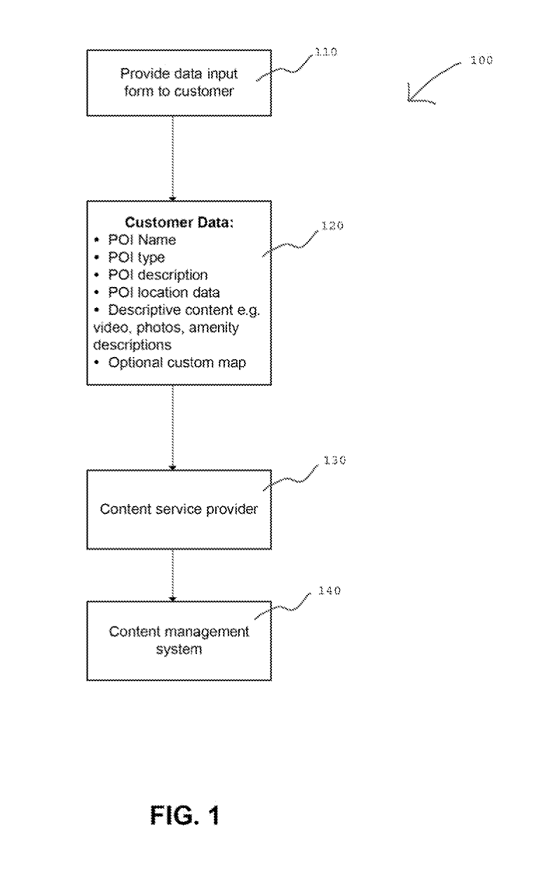

Referring now to the drawings wherein the showings are for purposes of illustrating embodiments of the invention only and not for purposes of limiting the same, FIG. 1 is a schematic diagram showing a process 100 for loading 140 data into a content management system (CMS). The process 100 includes the step of providing 110 an electronic data sheet to a customer. The electronic data sheet may include fields to be populated by the customer including information about the customer and/or the customer's point-of-interest. Thus, the second step of the process 100 includes populating 120 the fields of the electronic data sheet. The data sheet can then be provided 130 to a content service provider, for loading 140 into a content management system. In some embodiments, a customer may be given security credentials allowing it to perform the step of loading 140 without the need for action by the content service provider.

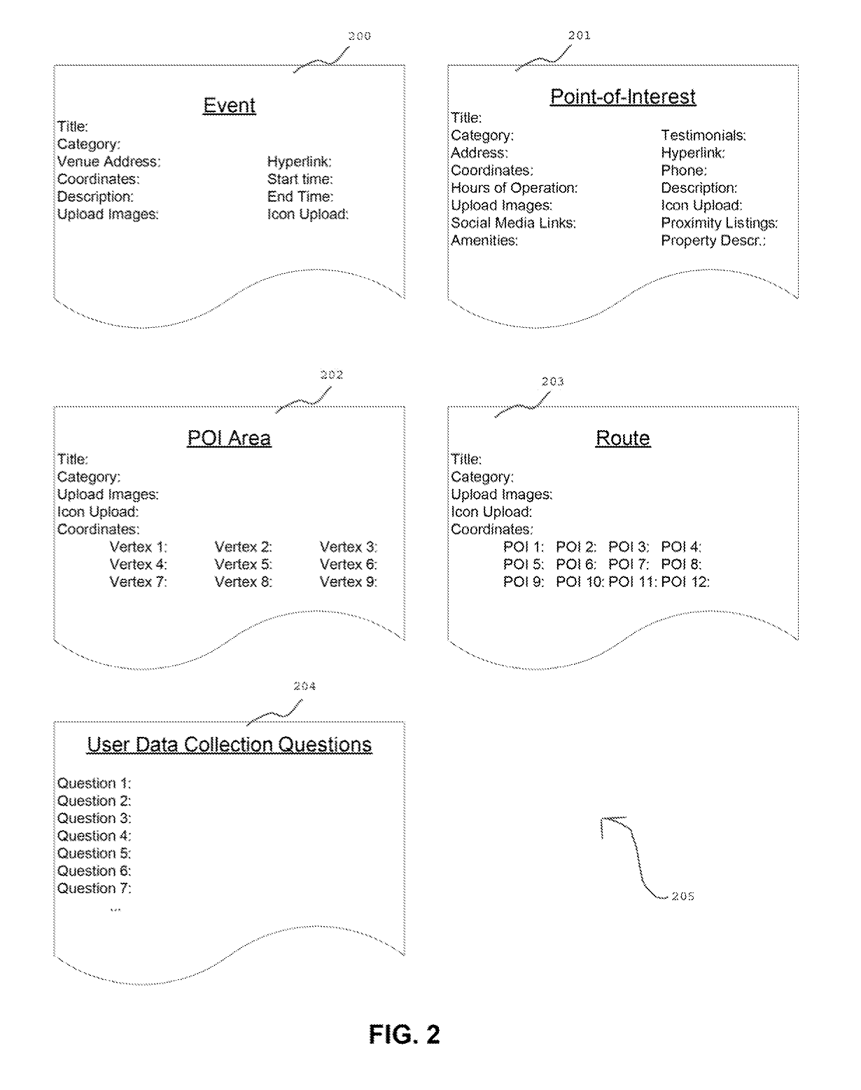

FIG. 2 shows several non-limiting examples of the kind of information that may be included in an electronic form 205 provided 110 to a customer. Data sheet 200 is a non-limiting example of an event form 200, and so it includes fields for information describing and pertaining to the event. For instance, an event form 200 includes the category of event, i.e. is it a rock concert, a wine tasting, play, etc. as well as the name of the event, the venue location, geographic coordinates, description of the event, the start and end times, and a hyperlink to a website about the event. Furthermore, event form 200 can include fields for multimedia files such as images, icons, and/or sound recordings. Similarly, point-of-interest form 201 can include fields for a title, category, address, geographic coordinates, hours of operation, amenities, testimonials, hyperlinks, telephone number, email address, a written description, as well as social media links, multimedia files and listings of nearby attractions and/or amenities, i.e. “proximity listings.”

With further regard to FIG. 2, an electronic point-of-interest area form 202 can include data for defining a point-of-interest area (POIA). Examples of data that can be included comprise a title, one or more categories for classifying the POIA, multimedia files relating the POIA, an icon, and geographic coordinates comprising vertices of a polygon defining the metes and bounds of the POIA. Although only nine (9) vertices are shown in this example, one of skill in the art will recognize that the number of vertices has no upper limit and can comprise as many points as necessary to adequately define the POIA.

With still further regard to FIG. 2, an electronic route form 203 can comprise data for defining a route. For example, suitable data may include a title of the route, one or more categories for classifying the route, one or more images or multimedia files and/or icons, and an ordered set of points-of-interest. In this non-limiting example 203, a route is defined by a set of up to twelve POIs numbered one through twelve. Accordingly, in this example 203 the POIs are arranged in the order in which they are to appear in the route; however, POIs may be rearranged and embodiments may include means for rearranging, adding, and/or deleting POIs of a route by a user, administrator, and/or customer.

With continued reference to FIG. 2, an electronic questions form 204 can comprise one or more questions which are to be asked of a user at predetermined points during their use of the interactive mapping system. For instance, a customer such as the owner of a POI may wish to pose questions to users to determine how better to serve them. Thus, a customer may specify in the electronic questions form 204 a list of questions to be asked. Questions may be asked randomly, at predetermined times, or in response to predetermined actions of a user. The form 204 may also include data indicating conditions for triggering the question(s). For instance, question three may be triggered to be asked when a selected variable or set of variable takes on a predetermined value. By way of further illustration, if a POI is located in Las Vegas, Nev. and the variable HomeTown is not equal to Las Vegas, and the variable HomeState is not equal to Nevada then the system might be triggered to ask a question relevant to visitors of Las Vegas, Nev. rather than people from the local area.

As shown in FIG. 2, electronic forms 205 can relate to points-of-interest 201, point-of-interest areas 202, routes 203, and/or can include a list of data collection questions to be posed to users during their use of the interactive mapping service; however, one skilled in the art will recognize that such electronic forms 205 can vary in structure, format, data type, and can contain a wide variety fields depending on their specific purpose. Accordingly, the forms 200, 201, 202, 203, and 204 shown in FIG. 2 are not intended to be an exclusive list. Furthermore, a form 205 according to embodiments of the invention can include report forms for providing data to a customer or administrator regarding, for instance, user activities, user inputs, replies to questions and/or surveys posed to users, and/or system status metrics indicating a state of the system's functionality or health.

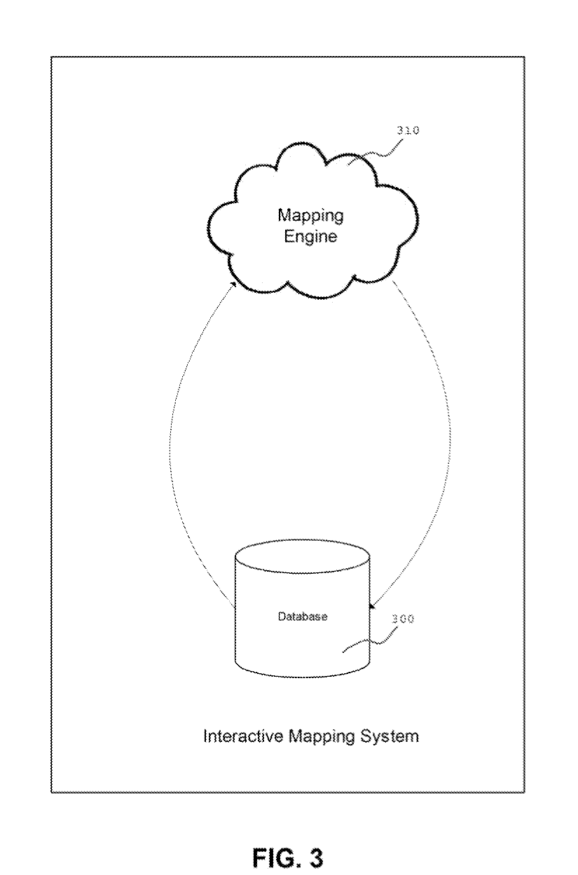

With reference to FIG. 3, a server-side database 300 can comprise a part of a CMS, and can be in bidirectional data communication with a remote mapping engine 310. According to this example, location data including one or more street addresses, cities, states, and/or zip codes can be recorded in the database 300 and can be transmitted to the remote mapping engine 310. The remote mapping engine 310 translates the location data into geographic coordinates which are then returned to the content management system and recorded in the database 300. Thus, a POI record can be precisely located on an interactive map.

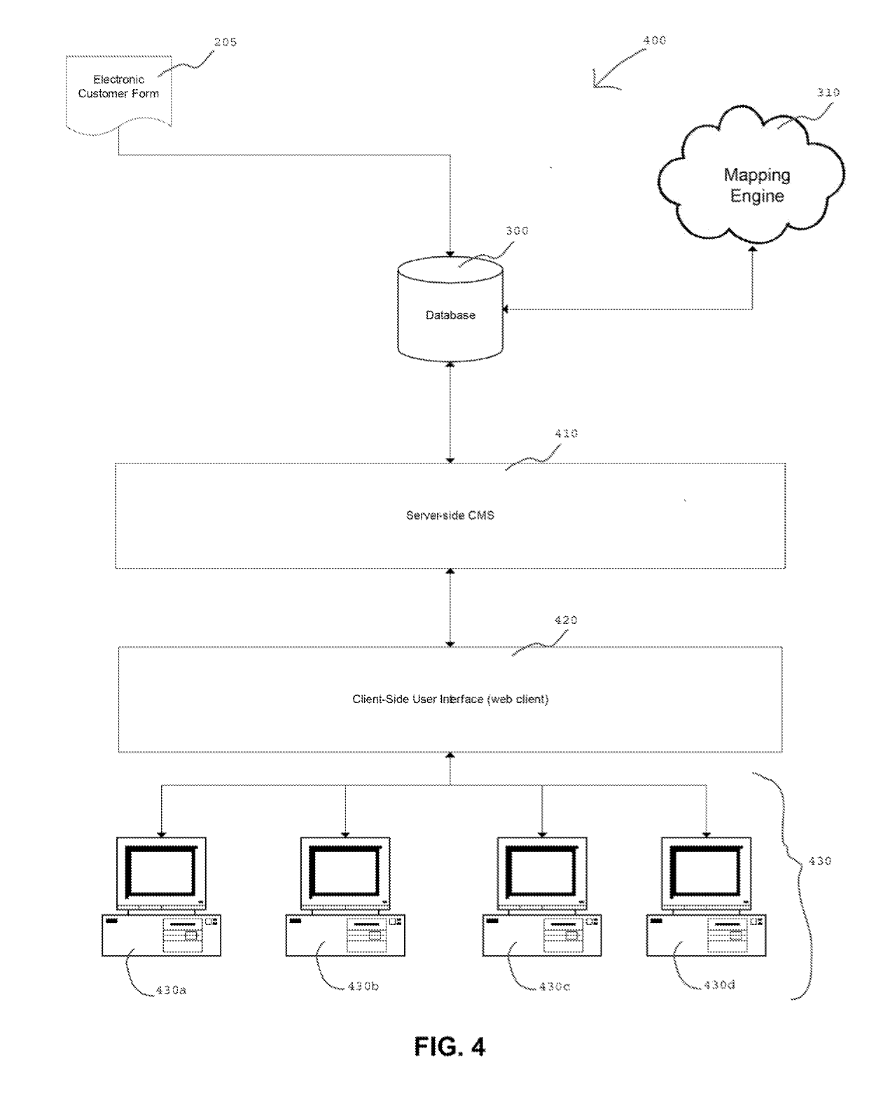

FIG. 4 is a schematic illustration of an interactive mapping architecture 400. According to FIG. 4 an interactive mapping architecture includes an electronic form 205 which is provided to a customer and which contains data fields which are populated by the customer. In this example, data in the electronic form 205 is transferred to and recorded in database 300. Database 300 is in electronic data communication with a server-side content management system (CMS) 410 and may form part of the CMS 410. The CMS 410 may include routines and/or modules for processing data contained in database 300 and for creating data structures defining, without limitation, POIs, POIAs, routes, and/or itineraries, and for serving said data and data structures to a client side user interface.

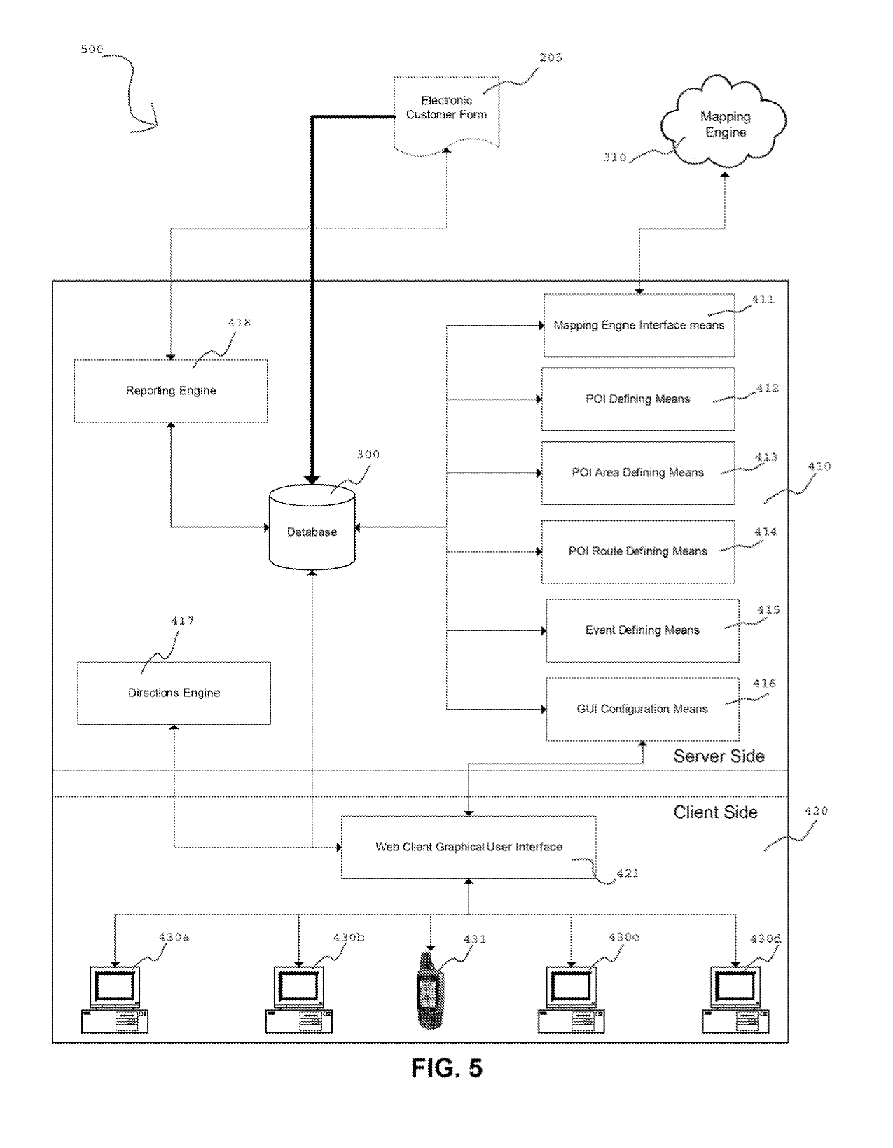

FIG. 5 is a more detailed schematic illustration of an interactive mapping architecture 500. In this example 500, an electronic customer form 205 is used to provide location data, such as one or more street addresses, to a database 300. According to the architecture of FIG. 5, the database 300 is part of a content managements system (CMS) 410. The CMS 410 includes a mapping engine interface 411 which is in data communication with a remote mapping engine 310 and with database 300. In one non-limiting example, the remote mapping engine 310 comprises Google Maps®; however, alternative mapping engines may be used including purpose-built mapping engines made for a particular embodiment. According to this example 500, the mapping engine interface 411 may retrieve location data from the database 300 and relay it to the remote mapping engine 310 for translation into geographic coordinates. The remote mapping engine then returns a corresponding set of geographic coordinates to the mapping engine interface 411, which may record the coordinate in the database 300 and/or relay the coordinates to another module of the CMS 410.

A CMS 410 may further comprise a POI defining means 412, which may function to assemble and/or configure data elements which define a POI into a convenient data structure. In some embodiments, a POI defining means 412 may also record the data in the database 300. Thus, a POI defining means 412 may be in data communication with the database 300. Similarly, a CMS 410 may include a POI area defining means 413, which may function to assemble and/or configure data elements which define a POI area into a convenient data structure and/or may record the data in the database 300. Still further, a CMS 410 may include a route defining means 414 and an event defining means 415 which may function to assemble and/or configure data defining a route or an event respectively into convenient data structures and may record the data in the database 300.

With continuing reference to FIG. 5, a server-side CMS 410 may also include a graphical user interface (GUI) configuration means 416, which may provide an administrator or service provider with tools to define a structure, content, and/or graphical layout of a client-side user interface 421. For example, a GUI configuration means 416 may be adapted to create menus including menu items, interactive calendars which may include events defined by the event defining means 415, interactive maps including POIs and POIAs defined by the POI defining means 412 and the POIA defining means 413 respectively, and/or routes defined by the route defining means 414. Furthermore, in some embodiments a GUI configuration means 416 may be adapted to provide a GUI with means for creating an itinerary and/or recording an itinerary in the database 300 for later recall, and may provide for user account formation and administration.

In some embodiments, a server-side CMS 410 may also include a directions engine 417 for generating turn-by-turn directions and providing them to a user based on a user-defined starting point and ending point. Embodiments may provide for turn-by-turn driving directions, walking directions, or other types of directions as may be necessary or desirable. Furthermore, in some embodiments, the directions may be provided in a static list form; however, other embodiments may interact with a user's GPS or GPS-enabled hand held device to provide directions from a user's current location.

The interactive mapping system 500 of FIG. 5 also includes a client-side 420 graphical user interface 421. In this example 500, the GUI 421 is a web client accessible from any web-enabled device such as a personal computer 430a, 40b, 430c, and 430d; or, from a hand-held device 431 such as a smart phone or tablet computer.

The interactive mapping system 500 of FIG. 5 further includes a reporting engine 418 in data communication with database 300. The reporting engine 418 may be adapted to provide reports on user activities and/or user inputs to, for example, a customer such as the owner of a POI may request reports from a service provider regarding user interactions with their POI. A reporting engine 418 provides the means for mining data from the database 300 and compiling the data into a convenient human-readable format. In some embodiments reports may be generated by a service provider and provided to a customer; however, in other embodiments a customer may be granted sufficient security credentials to access the reporting engine 418 and run reports of their own.

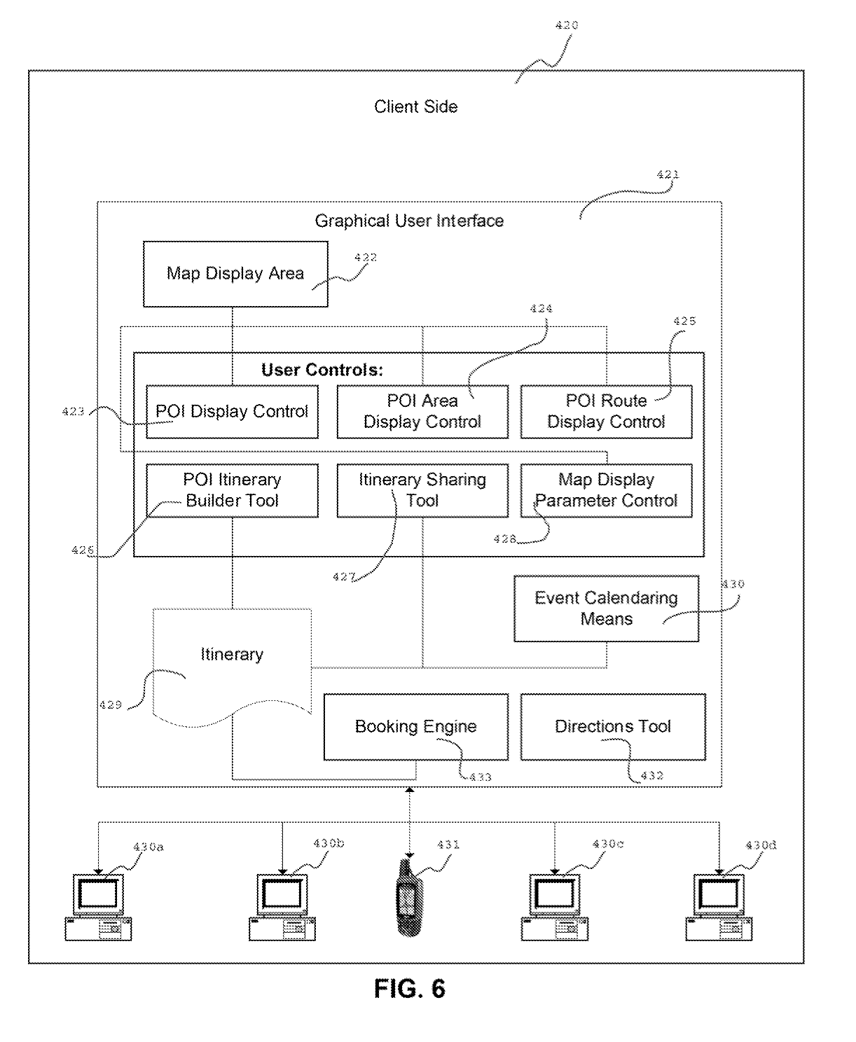

FIG. 6 is a schematic diagram of the client side 420 of an embodiment. According to the architecture of FIG. 6, a client side can include a graphical user interface (GUI) 421 and one or more user devices 430a, 430b, 430c, 430d, and 431 for interacting with the GUI 421. According to this embodiment, a GUI 421 can include a map display 422 comprising a visually perceptible interactive map, and a set of user controls including a POI display control 423, POIA display control 424, POI route display control 425, POI itinerary builder tool 426, an itinerary sharing tool 427, and a map display parameter control 428. One or more of these controls may be in data communication with the interactive map area 422.

In the example of FIG. 6 a POI display control 423 may be in data communication with the map display 422 and may be adapted to control the display of points-of-interest. For instance, a user may find it desirable to turn off the display of POI indicia so that he can better read a map, or it may be desirable to display only some of categories of POIs (e.g. hotels and restaurants) and not others (e.g. parks and tourist attractions). Thus, a POI display control 423 may be adapted to selectively display POIs according to category or according to any other advantageous parameter. Similarly, a POIA display control 424 and/or a POI route display control 245 may be in data communication with a map display 422 and may be adapted to selectively display one or more point-of-interest areas or POI routes respectively. In some embodiments, hiding a POIA or a POI route may also hide the POIs associated with the area or route.

With continuing reference to the example of FIG. 6, embodiments can include an events calendaring means 430, which may be adapted to retrieve event data from a database and display the event data to a user in a convenient format such as, without limitation, a calendar or list. Furthermore, an event calendaring means 430 may be adapted to retrieve events that are relevant to a user according to predetermined criteria and/or relevancy algorithm. Embodiments may also include means for a user to access further information regarding a selected event, and purchase tickets, make reservations, or otherwise sign up to attend an event, and the event calendaring means 430 may also add the event to a schedule or itinerary accessible to the user.

With further reference to FIG. 6, an embodiment can include an itinerary builder tool 426 adapted to enable a user to select POIs, POIAs, routes, and/or events and construct an itinerary therefrom. In some embodiments, an itinerary builder tool 426 can include a means for retrieving data from the database 300 and assembling and/or configuring the data into a convenient itinerary data structure which may be recorded in the database 300 for later recall. Additionally or alternatively, embodiments may provide for data communication between an itinerary 429 or itinerary data structure and an itinerary builder tool 426 and/or an events calendaring system 430. In some embodiments, data communication between an events calendaring tool 430 and an itinerary 429 may be via an itinerary builder tool 426.

Embodiments may further include a booking engine 433 which may be adapted to enable a user to book reservations at POIs such as, without limitation, hotels, restaurants, theaters and the like. Furthermore, in some embodiments booking may be completed automatically after a user provides billing information and authorization. Finally, some embodiments may include a tool for obtaining directions 432 for instance, from one POI to the next, or from one user-defined point to another. Furthermore, embodiments may include a means for interfacing with a user's GPS enabled device to provide real-time turn-by-turn directions according the user's current position.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. An interactive mapping system, comprising:
a server-side content management system comprising:
at least one database adapted to receive and record customer-provided data records and user input data records, the database containing at least one point-of-interest data record including at least on street address;
a means for interfacing with a mapping engine, including transmitting location data to the mapping engine and receiving corresponding geographic coordinates from the mapping engine;
a means for transferring customer-provided data from an electronic form to the at least one database;
a means for defining at least one point-of-interest including a set of geographic coordinates, and descriptive data including one or more of street address, category, cost of admittance, amenities, and/or rating data, and recording the geographic coordinates and descriptive data in the at least one database;
a means for defining at least one point-of-interest area on a first mapping display in data communication with the means for interfacing with the mapping engine including means for selecting predetermined locations on the first mapping display to define vertices of the point-of-interest area, communicating the vertices to the means for interfacing with the mapping engine, receiving geographic coordinates corresponding thereto from the mapping engine, recording the geographic coordinates in the at least one database and displaying indicia representing the vertices on the first mapping display;
a means for defining at least one route including a second mapping display in data communication with the means for interfacing with the mapping engine, the second mapping display including a plurality of points-of-interest, the means for defining at least one route further including a means for selecting one or more points-of-interest on the second mapping display, recording the selected points-of-interest as an ordered series of waypoints defining a route, the order of which corresponds to the order in which they were selected and the order in which they are to be visited along the route, and displaying indicia of a the route connecting one waypoint to the next;
a client-side user interface in data communication with the server-side content management system, the client-side user interface comprising:
a map display area including at least one displayed map, wherein the viewable area of the map is constrained according to predetermined parameters;
a user control for displaying one or more predefined points-of-interest on the displayed map;
a means for adding one or more of the points-of-interest to an itinerary;
a means for a user to share the itinerary with at least one other user;
a user control for displaying one or more predefined point-of-interest areas;
a user control for displaying one or more predefined point-of-interest routes; and
at least one display parameter control selected from one or more of panning, zoom, area selection, satellite view, terrain view, roadmap view, or hybrid view.

2. The interactive mapping system of claim 1, wherein the at least one displayed map in the client side map display area comprises a custom-drawn map of at least one point-of-interest area containing at least one point-of-interest, the custom-drawn map overlaying a map generated by the mapping engine, wherein the custom-drawn map is scaled and aligned to match the scale and alignment of the underlying map.

3. The interactive mapping system of claim 1, further comprising a server-side means for defining at least one event taking place at a point-of-interest, the event including a means for purchasing admittance to the event and/or adding the event to an itinerary, wherein one or more events can be displayed in a user interface in the form of a calendar, and wherein the events so displayed are determined to be relevant to the user according to predefined criteria including a user's selections of points-of-interest, routes, and/or itineraries.

4. The interactive mapping system of claim 1, further comprising a server-side means for defining questions to be asked of users at predetermined times.

5. The interactive mapping system of claim 1, further comprising a GPS feature for providing turn-by-turn directions to or within a point-of-interest from a user's current location, wherein the GPS feature may optionally operate on a custom-drawn map.

6. The interactive mapping system of claim 1, further comprising a means for pushing coupons to users based on their proximity to a point-of-interest and their selections of one or more points-of-interest, point-of-interest areas, routes and/or itineraries.

7. The interactive mapping system of claim 1, further comprising a booking engine interface providing users with a means for booking items selected from one or more of lodging, automobile rental, event admittance, park admittance, or venue admittance.

8. The interactive mapping system of claim 1, further comprising a tool for displaying property amenity data by clicking on a point-of-interest representing the property.

9. The interactive mapping system of claim 1, further comprising a flash card containing predefined information relevant to a point-of-interest, wherein the flash card is opened by a click, tap, or touch of visual indicia on an interactive map, and wherein the flash card comprises a popup or callout in proximal to the visual indicia and overlaying a portion of the map.

10. An interactive mapping system, comprising:
a server-side content management system comprising:
at least one database containing at least one point-of-interest data record including at least one street address;
a means for interfacing with a mapping engine, including transmitting a street address to the mapping engine and receiving corresponding geographic coordinates from the mapping engine;
a means for defining at least one point-of-interest including a set of geographic coordinates and recording the geographic coordinates in the at least one database;
a means for defining at least one point-of-interest area using at least three geographic coordinates and recording the geographic coordinates in the at least one database;
a means for defining at least one route using a plurality of geographic coordinates, configuring the plurality of geographic coordinates as a series of waypoints, and recording the series of waypoints in the at least one database; and
a client-side user interface in data communication with the server-side content management system, the client-side user interface comprising:
a map display area including at least one displayed map, wherein the viewable area of the map is constrained according to predetermined parameters;
a user control for displaying one or more predefined points-of-interest on the displayed map;
a means for adding one or more of the points-of-interest to an itinerary;
a means for a user to share the itinerary with at least one other user;
a user control for displaying one or more predefined point-of-interest areas; and
a user control for displaying one or more predefined point-of-interest routes.

11. The system of claim 10, wherein the means for defining at least one point-of-interest area includes a first mapping display in data communication with the means for interfacing with the mapping engine including means for selecting predetermined locations on the first mapping display to define vertices of the point-of-interest area, communicating the vertices to the means for interfacing with the mapping engine, receiving geographic coordinates corresponding thereto from the mapping engine, recording the geographic coordinates in the at least one database and displaying indicia representing the vertices on the first mapping display.

12. The system of claim 10, wherein the means for defining at least one route includes a second mapping display in data communication with the means for interfacing with the mapping engine, the second mapping display including a plurality of points-of-interest, the means for defining at least one route further including a means for selecting one or more points-of-interest on the second mapping display, recording the selected points-of-interest as an ordered series of waypoints defining a route, the order of which corresponds to the order in which they were selected and the order in which they are to be visited along the route, and displaying indicia of a the route connecting one waypoint to the next.

13. The interactive mapping system of claim 10, wherein the at least one displayed map in the client side map display area comprises a custom-drawn map of at least one point-of-interest area containing at least one point-of-interest, the custom-drawn map overlaying a map generated by the mapping engine, wherein the custom-drawn map is scaled and aligned to match the scale and alignment of the underlying map.

14. The interactive mapping system of claim 10, further comprising a means for pushing coupons to users based on their proximity to a point-of-interest and their selections of one or more points-of-interest, point-of-interest areas, routes and/or itineraries.

15. The interactive mapping system of claim 10, further comprising a flash card displaying data about an item located at a point of interest said information being selected from one or more of educational data, historical data, or purchasing data.
